(19) United States
(12) Patent Application Publication
(10) Pub. No.: US 2025/0392055 A1
(43) Pub. Date: Dec. 25, 2025

(54) ANTENNA AS WELL AS MOBILE COMMUNICATION CELL SITE

(71) Applicant: Telefonaktiebolaget LM Ericsson (publ), Stockholm (SE)

(72) Inventors: Philipp Ponn, Rosenheim (DE); Christoph Staita, Oberaudorf (DE); Andreas Vollmer, Rosenheim (DE); Maximilian Obermayer, Rosenheim (DE)

(21) Appl. No.: 18/880,609

(22) PCT Filed: Jul. 5, 2022
(86) PCT No.: PCT/EP2022/068560

§ 371 Date: Jan. 2, 2025

(51) Int. Cl. H01Q 21/06; H01Q 5/42; H01Q 13/08; H01Q 21/24

(52) U.S. Cl. CPC H01Q 21/064; H01Q 5/42; H01Q 13/085; H01Q 21/24; H01Q 21/062

(57) ABSTRACT

An antenna, in particular for a mobile communication cell site, has a first array of first radiators and at least one second array of second radiators. The first array is arranged at least in parts above at least parts of the second array, and the first radiators, that are arranged at least in parts above at least one of the second radiators, are unidirectional radiators. Further, a mobile communication cell site is shown.

### TECHNICAL FIELD

The invention relates to an antenna for a mobile communication cell site as well as a mobile communication cell site.

### BACKGROUND

Multiband antennas are known in the art. In such antennas, a first antenna array and a second antenna array are located to provide the necessary multiband functionality. Usually, reflector based architectures for the first and second antenna array are used.

At the same time, the multiband antenna has to be very compact in size. To this end, it is known to have the first antenna array at least partly overlap the second antenna array. However, the reflector of the first antenna array does deteriorate the beam quality of the underlying second antenna array. To reduce this deterioration, it is known to use frequency selective layers as a reflector for the first antenna array.

The use of the frequency selective layers still leads to beam deterioration as their bandwidth is limited.

### SUMMARY

It is thus the object of the invention to provide a multiband antenna as well as a mobile communication cell site providing a high beam quality while having a compact size.

For this purpose, an antenna, in particular for a mobile communication cell site is provided. The antenna comprises a first array of first radiators and at least one second array of second radiators. The first array is arranged at least in parts above at least parts of the second array, and the first radiators, that are arranged at least in parts above at least one of the second radiators, are unidirectional radiators.

By using unidirectional radiators, e.g. radiators having a unidirectional far-field characteristics without a reflector, as radiators of the first array, a reflector for the first array is not necessary anymore. Thus, the first array and the second array can overlap each other leading to a compact antenna size without compromising the beam quality of the second array.

The first radiators that are arranged at least in parts above the second radiators overlap with at least one of the second radiators in a projection in the radiation direction. In other words, it may be said that the first radiators that are arranged at least in parts above the second radiators are directly above in the sense of no lateral offset. The same applies for the part of the first array which is arranged above at least parts of the second array, i.e. this part of the first array is directly above the respective part of the second array in the sense that there is no lateral offset between said parts.

The antenna comprises a radiation direction and terms like “above” are to be understood with respect to the radiation direction.

In an aspect, the antenna is free of a reflector between the first radiators and the corresponding second radiators and/or the first radiators are free of a reflector. Due to the absence of a reflector, the beam quality of the second array is improved.

This includes, in particular, frequency selective layers serving as a reflector.

For example, the first radiators are designed for at least two frequency ranges, each frequency range having at least 500 MHz bandwidth and/or at least 20% relative bandwidth and/or a return loss of better than 6 dB, preferably better than 10 dB, more preferably better than 14 dB.

It is conceivable that at least one of the first radiators is designed in the frequency range of the second radiators and/or that the antenna comprises a coupler or diplexer, wherein at least one of the first radiators is connected with one of the second radiators via the coupler or the diplexer.

For providing reliable first radiators, the first radiators are travelling wave radiators in an embodiment.

The first radiators may be dual-polarized radiators making use of both polarizations.

In an embodiment, the first radiators are tapered slot radiators, in particular one of the first radiators may be formed by a metallization applied to a substrate, providing reliable unidirectional radiators.

It is also conceivable that the tapered slot radiator is formed of a metal sheet, of one or more metal layers of a printed circuit board or of electrically conductive areas in a molded interconnect device (MID).

The first array and the second array may be interleaved with one another.

In an aspect, the second array is an active antenna array and/or the first array is a passive antenna array. This way, the size of the antenna can be reduced further.

In particular, the active antenna array also comprises an amplifier in the antenna itself.

For a compact arrangement, the first array may comprise at least one column of first radiators adjacent to the second array, in particular wherein the second array may be located between two columns of the first radiators of the first array.

In an embodiment, the first radiators, in particular the first radiators that are arranged at least in parts above at least one of the second radiators, have an inner portion and an outer edge, wherein the outer edge is provided with an adaption structure. The adaption structure further increases the beam quality of the second array.

The adaption structure is not a reflector, e.g. a structure a perpendicular to the radiation direction for reflecting radiation emitted by a separate radiator.

For example, the adaption structure is designed such that it dampens back radiation from the first radiator and/or such that at least parts of the first radiator comprising the adaption structure are transparent for electromagnetic radiation having frequencies in the frequency range of the second array. This way, the beam quality of the second array can be improved further.

In an embodiment, the adaption structure comprises protrusions extending outward with respect to the inner portion forming a comb, reliably suppressing back radiation.

In another embodiment, the outer edge comprises an upper end and a lower end connected together by the adaption structure, the adaption structure comprising electrically conductive segments and inductive segments in alternating fashion, increasing the transmission through the first radiators.

For further improvement, the electrically conductive segments and the inductive segments may be coupled capacitively or galvanically.

In an embodiment, the adaption structure comprises an extension portion galvanically separate from a radiation edge of the respective first radiator and extending from the outer end of the radiation edge further outwards, improving the antenna gain.

The extension portion may be above the second radiators. For example, the extension portion may be a metallization on the other side of the substrate than the radiation edge.

To provide a cost efficient antenna, the antenna may comprise at least one substrate, wherein a metallization applied to the substrate forms at least parts of at least one of the respective first radiators and/or at least parts of the adaption structure, in particular wherein the extension portion of the adaption structure is provided on a side of the substrate opposite to a side having the respective first radiator.

In an aspect, the inductive segments of the adaption structure are formed as part of a metallization on a side of the substrate opposite to a side having the electrically conductive segments of the adaption structure, in particular wherein the electrically conductive segments are formed on the same side as the respective radiation edge allowing efficient manufacturing of the adaption structure.

The inductive and electrically conductive segments may be coupled capacitively through the substrate.

In an embodiment, the antenna comprises at least two substrates intersecting one another perpendicularly, wherein the metallizations on both intersecting substrates in the region of the intersection form one of the dual-polarized first radiators, further reducing manufacturing costs.

For example, the first array is provided in a housing separate from the housing of the second array.

In another aspect, the second array defines a grid of radiator locations, wherein the first antennas are located at radiator locations of the grid defined by the second array. This way, the second array may be enlarged, in particular if the first radiators are broadband.

For the above mentioned purpose, further a mobile communication cell site is provided comprising an antenna as described in one of the embodiments mentioned above.

The features and advantages of the antenna also apply to the mobile communication cell site and vice versa.

### BRIEF DESCRIPTION OF THE DRAWINGS

Further features and advantages will be apparent from the following description as well as the accompanying drawings, to which reference is made. In the drawings:

FIG. 1 shows a mobile communication base station according to an embodiment of the invention with an antenna according to an embodiment of the invention,

FIG. 2 shows the antenna according to FIG. 1 in a schematic top view,

FIG. 3 shows a perspective view of the antenna according to FIG. 1,

FIG. 4 shows a simplified side view of the antenna according to FIG. 1,

FIGS. 5, 6 show different sides of a substrate to which a metallization forming a radiator for an antenna according to FIG. 1 has been applied,

FIG. 7 shows a part of a first radiator of a second embodiment of an antenna according to the invention,

FIG. 8 shows a part of a first radiator of a third embodiment of an antenna according to the invention,

FIG. 9 shows a part of a first radiator of a fourth embodiment of an antenna according to the invention,

FIG. 10 shows a schematic top view of a fifth embodiment of an antenna according to the invention,

FIG. 11 shows a part of a first radiator of a sixth embodiment of an antenna according to the invention,

FIG. 12 shows the first array of the antenna of the sixth embodiment in an exploded view, and

FIG. 13 shows the antenna of the sixth embodiment in an exploded view.

### DETAILED DESCRIPTION

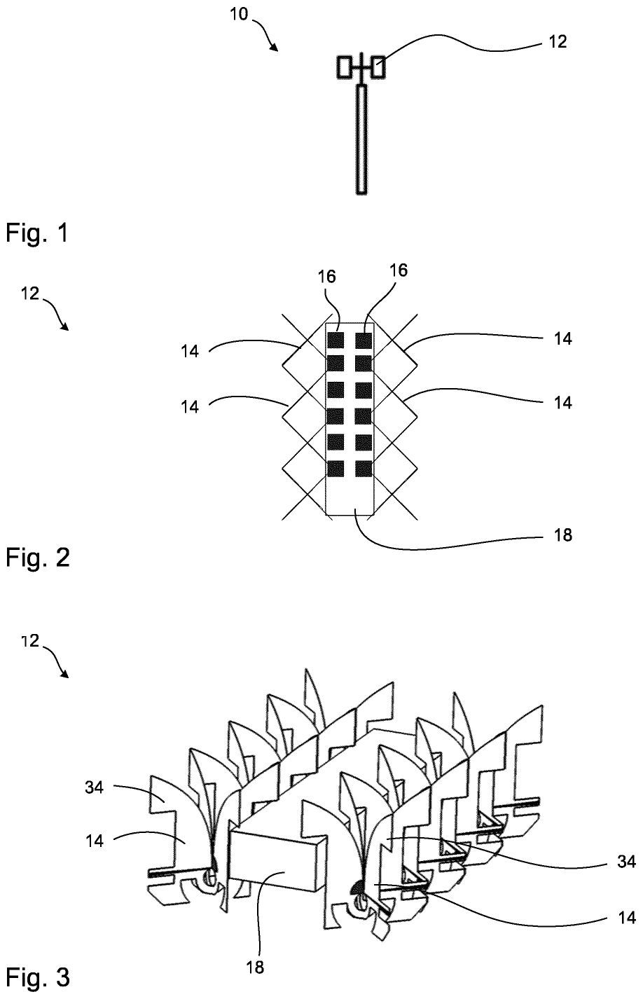

FIG. 1 shows a mobile communication cell site 10 according to an embodiment schematically. The cell site 10 has two antennas 12.

FIG. 2 shows schematically a top view onto the radiators of one of the antennas 12. The antenna 12 comprises a plurality of first radiators 14 and a plurality of second radiators 16.

The first radiators 14 are arranged in a first array, in the shown embodiment an array having two columns of first radiators 14.

The first radiators 14 may be designed for at least two frequency ranges, each frequency range having at least 500 MHz bandwidth and/or at least 20% relative bandwidth and/or a return loss of better than 6 dB, preferably better than 10 dB, more preferably better than 14 dB.

The second radiators 16 also form an array called the second array in the following. The second radiators 16 and thus the second array is designed for a specific design frequency range.

The second array is in particular an active array, meaning that the necessary amplifiers for generating the respective signals for the second radiators 16 are located right at the second array, in particular in the same housing 18 as the second radiators 16.

As can be seen in FIG. 2, the second array is arranged between the two columns of the first array.

The first and the second array are thus interleaved with one another.

It is conceivable that at least one of the first radiators 14 is designed for the design frequency range of the second radiators 16.

The antenna 12 may comprise a coupler or diplexer, wherein at least one of the first radiators 14 is connected with one of the second radiators 16 via the coupler or the diplexer. This way, add new subarrays in the design frequency range of the second radiators 16 and/or a change in the far-field characteristic of at least one of the second radiators 16 is achievable.

Thus, two columns of the first array are adjacent to the second array. The first radiators 14 of these columns adjacent to the second array partly overlap with the second array, in particular with parts of the respective second radiators 16.

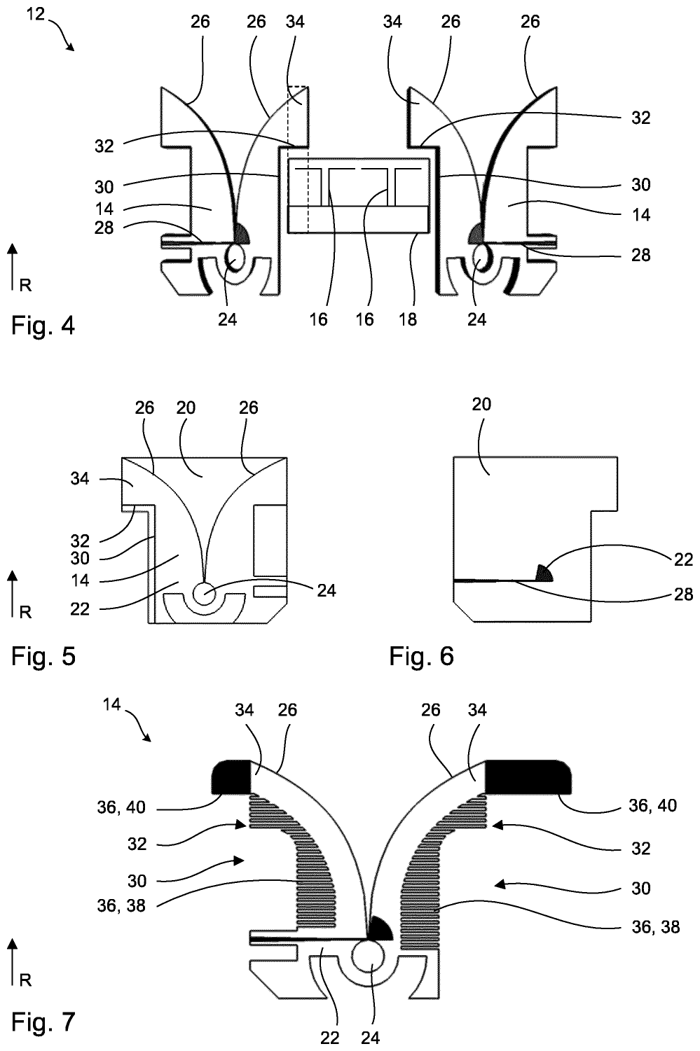

FIGS. 3 and 4 show a perspective view and a side view, respectively, of the antenna 12 shown in FIG. 2. The overlap between the first radiators 14 of the column adjacent to the second array and the second array can clearly be seen.

For the sake of simplicity, the second radiators 16 are not shown but the second array is depicted by its housing 18.

The second radiators 16 may be dipole radiators known in the art. As such, the second radiators 16 are not unidirectional radiators so that they comprise a reflector for emitting electromagnetic radiation in the radiation direction R of the antenna 12.

The first radiators 14 are unidirectional radiators. Thus, the first radiators 14 do not necessitate a reflector for emitting the electromagnetic radiation in the radiation direction R of the antenna 12.

A unidirectional radiator may be regarded as a radiator having a forward gain of at least 5 dBi, in particular of at least 7 dBi, in particular without the need for a separate reflector.

In the illustrated embodiment, the first radiators 14 are traveling wave radiators, in particular tapered slot radiators.

The first radiators 14 may be formed by a metallization applied to a substrate, as will be explained later. In FIGS. 3 and 4, for the sake of simplicity, the substrate is not shown.

It is also conceivable that at least one, in particular all of the first radiators 14 are tapered slot radiators formed of a metal sheet, of one or more metal layers of a printed circuit board or of electrically conductive areas in a molded interconnect device (MID). The first radiators 14 that are adjacent to the second array comprise portions that extend in the area above the second array, i.e. in an area without lateral offset to at least one of the second radiators 16.

Within this disclosure, above means that parts of the first radiators 14 overlap with the second array, in particular at least parts of at least one of the second radiators 16 in a projection in the radiation direction R.

The area of overlap is shown with dashed lines in FIG. 4. Further, no reflector is present between the first radiators 14 and the second radiators 16, not even in form of a frequency selective layer.

As best seen in FIG. 3, the first radiators 14 are dual-polarized radiators that are, for example, made of two tapered slot radiators arranged concentrically and perpendicular to each other.

FIGS. 5 and 6 show one of the traveling wave radiators of the first radiators 14 in a front and back view.

The antenna 12 comprises a substrate 20 on which the first radiators 14 are partly applied, i.e. one of the two tapered slot radiators of one dual-polarized first radiator 14 is applied to one substrate 20.

Onto the substrate 20, metallizations 22 are applied, in particular on both sides of the substrate 20.

On one of the sides of the substrate 20, the metallization 22 forms a tapered slot radiator being one radiator of one of the dual-polarized first radiators 14.

In the following, only one of the two tapered slot radiators of the dual-polarized first radiators 14 is described. The second tapered slot radiator of the first radiators 14 is designed in the same fashion. In the following, it is referred to the first radiator 14 for the sake of simplicity, even if only one of the dual-polarized radiators is described.

In cases where the first radiators 14 are not dual-polarized radiators, the described tapered slot radiator is the entire first radiator 14.

In this first embodiment, the metallization 22 and thus the tapered slot radiator is substantially designed as known in the art.

The first radiator 14 comprises a resonator 24 in the metallization 22. Two radiation edges 26 start from the resonator 24 and extend upwardly and outwardly forming a tapered slot.

The first radiator 14, i.e. the metallization 22, also comprises an outer edge 30 that is directed towards the second array and the second radiators 16, respectively.

The outer edge 30 delimits the first radiator 14, i.e. the metallization 22, sideways and to the back.

At the upper end, the outer edge 30 has a collar 32 so that the first radiator 14, i.e. the respective section of the metallization 22, comprises a wing portion 34. It is the wing portion 34 which overlaps with the second radiator 16 and the second array, respectively.

In the shown embodiment, the substrate 20 has, at least on the side facing the second array, a similar shape as the outer edge 30, meaning that also the substrate 20 forms a collar.

As best seen in FIGS. 3 and 4, the second array is arranged between the first radiators 14, and the wing portions 34 of the first radiators 14 are located above at least parts of the second array and the second radiators 16.

This way, a very compact multiband antenna is provided with very high beam quality of the second array as no reflector for the first radiators 14 is necessary which would deteriorate the beam quality.

On the other side of the substrate 20, shown in FIG. 6, the metallization 22 applied to the substrate 20 comprises a feeding line 28 for feeding the first radiator 14.

FIGS. 7 to 13 show further embodiments of an antenna according to the invention which correspond substantially to the first embodiment discussed with respect to FIGS. 2 to 6. Thus, in the following only the differences are discussed and the same and functionally the same components are labeled with the same reference signs.

FIG. 7 shows a first radiator 14 of a second embodiment of the antenna. More precisely, FIG. 7 shows the metallization 22 forming one tapered slot radiator of the first radiator 14 being a dual-polarized radiator. The substrate is not shown for reasons of clarity.

In this second embodiment, the first radiators 14, at least the ones of the first radiators 14 that at least partly overlap with the second array, comprise an adaption structure 36 designed to reduce interference between the first radiators 14 and the second radiators 16.

In the second embodiment, the adaption structure 36 comprises a plurality of protrusions 38 as well as extension portions 40.

The protrusions 38 are formed at the outer edge 30 and extend perpendicular to the radiation direction R outwardly. They may form a comb.

In particular, the protrusions 38 are in the same plane as the radiation edges 26. They may be finger shaped protrusions of the metallization 22.

In the shown embodiment, protrusions 38 are provided at both outer edges 30.

The extension portions 40 are also formed as part of the metallization 22, but at the side of the substrate 20 opposite to the side of the radiation edges 26.

As seen in FIG. 7, which shows a projection perpendicular to the radiation direction R, the extension portions 40 extend from the wing portions 34 further outwards. However, due to the fact that the extension portion 40 and the wing portions 34 are provided on opposite sides of the substrate 20, no electrically conductive connection between them is provided. For example, no overlap between the extension portion 40 and the wing portion 34 is present.

It is also conceivable that only one extension portion 40 is present, in particular on the side facing the second array.

The adaption structure 36 reduces back radiation from the first radiator 14, i.e. the radiation of the first radiator 14 in the direction opposite to the radiation direction R as such, the adaption structure 36 improves.

Further, the adaption structure 36 increases the transparency of the first radiators 14, at least in the region of the overlap, for electromagnetic radiation having frequencies in the frequency range of the second array. Thus, the beam quality of the second array is not influenced by the first radiators 14.

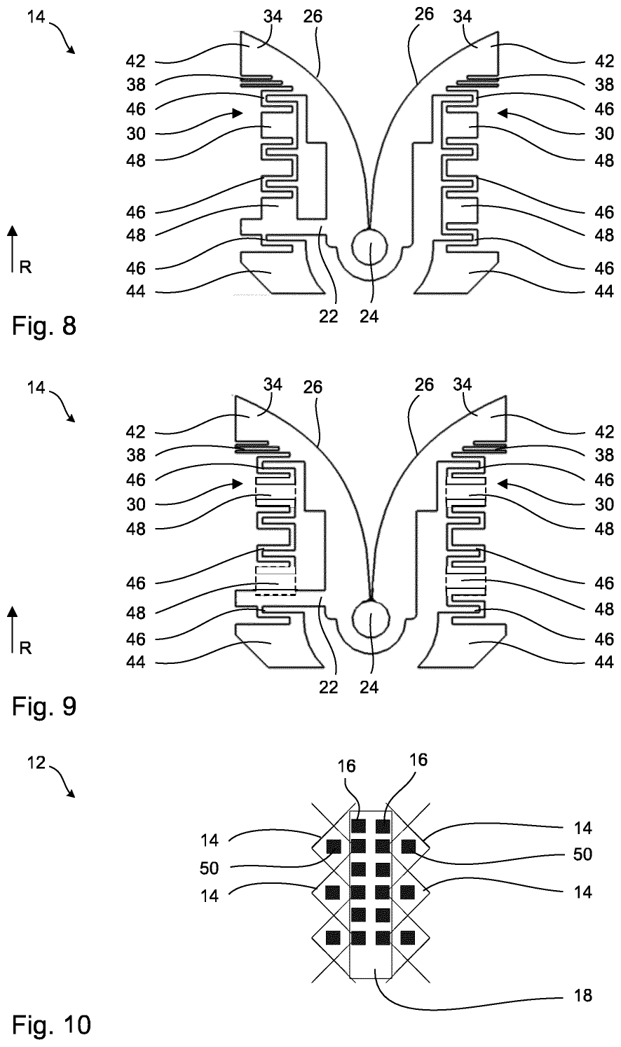

FIG. 8 shows a first radiator 14 of a third embodiment of the antenna 12, also comprising an adaption structure 36.

In this embodiment, the outer edge 30 comprises an upper end 42 adjacent to the radiation edge 26 and a lower end 44 in the region of the resonator 24.

The adaption structure 36 is arranged between the upper end 42 and the lower end 44 and electrically connects the upper end 42 with the lower end 44.

In the third embodiment, the adaption structure 36, as part of the metallization 22, comprises electrically conductive segments 46 and inductive segments 48. The adaption structure 36 is, in particular, on the same side as the radiation edges 26.

The electrically conductive segments 46 are formed as conducting lines and the inductive segments 48 are provided as rectangular segments of the metallization 22.

The electrically conductive segments 46 and the inductive segments 48 are arranged alternatingly between the upper end 42 and the lower end 44, this way connecting both ends 42, 44.

FIG. 9 shows a first radiator 14 of a fourth embodiment of the antenna 12.

The fourth embodiment substantially corresponds to the third embodiment with the difference that the inductive segments are located on the opposite side of the substrate 20 than the electrically conductive segments 46.

For example, the electrically conductive segments 46 are located on the same side as the radiation edges 26 and the inductive segments 48 are located on the opposite sides of the substrate 20, e.g. the side having the feeding line 28.

The electrically conductive segments 46 do overlap with the inductive segments 48 so that the electrically conductive segments 46 and the inductive segments 48 are coupled capacitively through the substrate 20. It could also be said that the adaption structure 36 comprises capacitive segments between the electrically conductive segments 46 and the inductive segments 48.

FIG. 10 shows a fifth embodiment of the antenna 12 in a schematic top view similar to that of FIG. 2.

In this embodiment, the second array defines a grid of radiator locations, wherein the second radiators 16 are located exclusively at the radiator locations.

Also in this embodiment, the first radiators 14 are located on radiator locations of the grid defined by the second array, wherein the first radiators 14 are located in columns of the grid different from the column of the second radiators 16.

For example, the antenna 12 may also comprise third radiators 50, which are also located on radiator locations of the grid of the second array. In the shown embodiment, in the columns adjacent to the second radiators 16, the first radiators 14 and the third radiators 50 are arranged in alternating fashion.

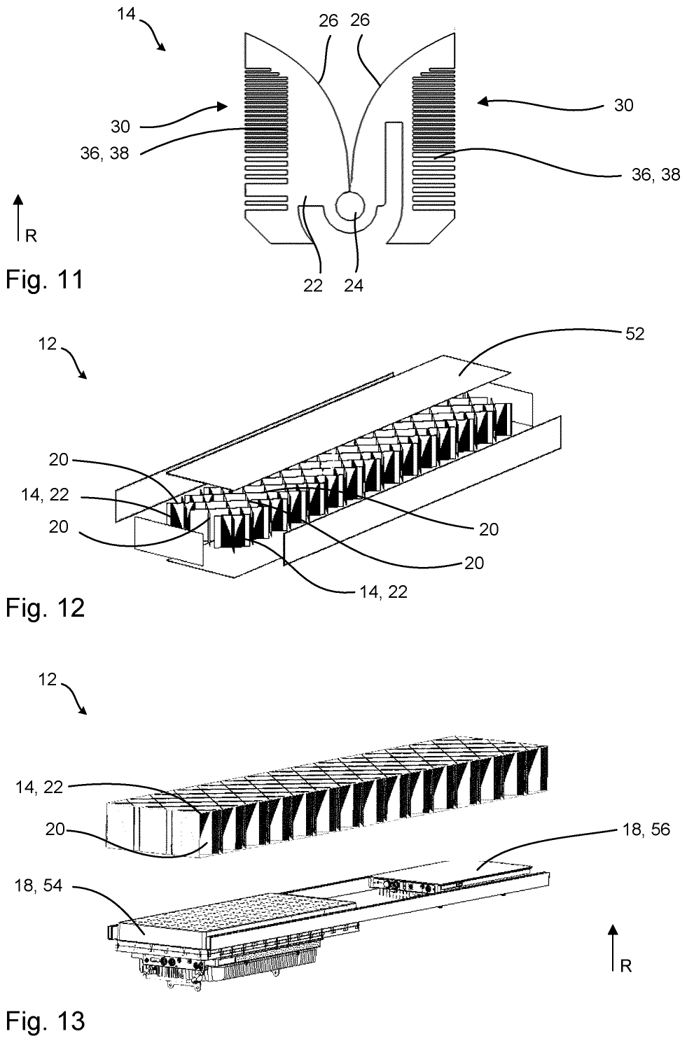

FIGS. 11, 12 and 13 show a sixth embodiment of an antenna 12 according to the invention.

FIG. 11 shows a first radiator 14, more precisely a tapered slot radiator of a dual-polarized first radiator 14 similar to that of the second embodiment shown in FIG. 7.

The first radiator 14 comprises the adaption structure 36 having extension portions 40 forming a comb. However, the first radiator 14 does not comprise a wing portion 34 or a collar 32.

FIG. 12 shows the first array in an exploded view. The antenna 12 comprises several substrates 20 that, in difference to the embodiments discussed above, comprise metallizations 22 forming parts of more than one first radiator 14.

The substrates 20 intersect each other perpendicularly, in particular one substrate 20 intersects more than one other substrate 20.

The metallizations 22 on two intersecting substrates 20 form one dual-polarized first radiator 14 in the region of the intersection.

The substrates 20 and thus the first radiators 14 are arranged in a squared honeycomb structure.

Further, in the sixth embodiment, the antenna 12 comprises a housing 52 for the first radiators 14. The housing may be made of plastics and does not have reflective properties neither in the frequency range of the first array nor in the frequency range of the second array.

FIG. 13 shows an exploded view of the antenna 12 according to the sixth embodiment, wherein the housing 52 of the first array has been omitted.

The antenna 12 comprises two second arrays 54, 56 wherein each of the second arrays 54, 56 is designed for a different frequency range. The first array, i.e. the first radiators 14, are mounted above the second arrays 54, 56. In the shown embodiment, the first radiators 14 are arranged entirely above the second arrays 54, 56. This embodiment leads to a very compact construction.

The features of the various embodiments may be combined. For example, the extension portions 40 may also be present in other embodiments. Likewise, only one second array may be present in the sixth embodiment or two or more second arrays may be provided in any other embodiment.

1. Antenna, in particular for a mobile communication cell site, comprising a first array of first radiators and at least one second array of second radiators,
wherein the first array is arranged at least in parts above at least parts of the second array, and
wherein the first radiators, that are arranged at least in parts above at least one of the second radiators, are unidirectional radiators.

2. Antenna according to claim 1, characterized in that the antenna is free of a reflector between the first radiators and the corresponding second radiators and/or that the first radiators are free of a reflector.

3. Antenna according to claim 1, characterized in that the first radiators are travelling wave radiators and/or dual-polarized radiators.

4. Antenna according to claim 1, characterized in that the first radiators are tapered slot radiators, in particular formed by at least one metallization applied to at least one substrate.

5. Antenna according to claim 1, characterized in that the second array is an active array and/or that the first array is a passive array.

6. Antenna according to claim 1, characterized in that the first array comprises at least one column of the first radiators adjacent to the second array, in particular wherein the second array is located between two columns of the first radiators of the first array.

7. Antenna according to claim 1, characterized in that the first radiators, in particular the first radiators that are arranged at least in parts above at least one of the second radiators, have an inner portion and an outer edge, wherein the outer edge is provided with an adaption structure.

8. Antenna according to claim 7, characterized in that the adaption structure is designed such that it dampens back radiation from the first radiator and/or such that at least parts of the first radiator comprising the adaption structure are transparent for electromagnetic radiation having frequencies in a design frequency range of the second array.

9. Antenna according to claim 7, characterized in that the adaption structure comprises protrusions extending outward with respect to the inner portion forming a comb.

10. Antenna according to claim 7, characterized in that the outer edge comprises an upper end and a lower end connected together by the adaption structure, the adaption structure comprising electrically conductive segments and inductive segments in alternating fashion.

11. Antenna according to claim 10, characterized in that the electrically conductive segments and the inductive segments are coupled capacitively or galvanically.

12. Antenna according to claim 7, characterized in that the adaption structure comprises an extension portion galvanically separate from a radiation edge of the respective first radiator and extending from the outer end of the radiation edge further outwards.

13. Antenna according to claim 1, characterized in that the antenna comprises at least one substrate, wherein a metallization applied to the substrate forms at least parts of at least one of the respective first radiators and/or at least parts of the adaption structure, in particular wherein the extension portion of the adaption structure is provided on a side of the substrate opposite to a side having the respective first radiator.

14. Antenna according to claim 13, characterized in that the inductive segments of the adaption structure are formed as part of a metallization on a side of the substrate opposite to a side having the electrically conductive segments of the adaption structure, in particular wherein the electrically conductive segments are formed on the same side as the respective radiation edge.

15. Antenna according to claim 13, characterized in that the antenna comprises at least two substrates intersecting one another perpendicularly, wherein the metallizations on both intersecting substrates in the region of the intersection form one of the dual-polarized first radiators.

16. Antenna according to claim 1, characterized in that the second array defines a grid of radiator locations, wherein the first radiators are located at radiator locations of the grid defined by the second array.

17. Mobile communication cell site comprising an antenna, the antenna comprising:
a first array of first radiators and at least one second array of second radiators,
wherein the first array is arranged at least in parts above at least parts of the second array, and
wherein the first radiators, that are arranged at least in parts above at least one of the second radiators, are unidirectional radiators.
